(19) United States
(12) Patent Application Publication
(10) Pub. No.: US 2004/0153257 A1
(43) Pub. Date: Aug. 5, 2004

(54) Graphical display for medical devices and methods for displaying medical information

(76) Inventor: Jens Aage Munk, Olstykke (DK)

Correspondence Address: NOVO NORDISK PHARMACEUTICALS, INC, 100 COLLEGE ROAD WEST, PRINCETON, NY, 08540, US

(21) Appl. No.: 10/731,350

(22) Filed: Dec. 9, 2003

Related U.S. Application Data
(60) Provisional application No. 60/434,559, filed on Dec. 19, 2002.

(30) Foreign Application Priority Data
Feb. 4, 2003 (DK) PA 2003 00154

(51) Int. Cl. G06F 19/00

(52) U.S. Cl. 702/31

(57) ABSTRACT

A graphical display for a medical monitor includes a graphical means for displaying past, present and future predicted values. The display may also show trend data and indicate whether a patient's condition or a monitored parameter is improving. The display may be pictorial, or be a combination of graphics and text. Colors, blinking, shading, and moving arrows may illustrate and communicate various information to a patient using the display. The display is well suited for use with various devices, including continuous blood glucose monitors. In some cases the display will be integral with the monitoring means, in other cases, typically bifurcated devices, the display will be used on a monitor that is interfaced or otherwise communicates with the sensor and measuring the patient's condition. In some cases the sensor might be remotely located on the patient and it might communicate with a processor that is interfaced with a monitor having the above described display.

### CROSS-REFERENCE TO RELATED APPLICATIONS

This application claims priority under 35 U.S.C. 119 of Danish application no. PA 2003 00154 filed Feb. 4, 2003 and U.S. application No. 60/434559 filed Dec. 19, 2002, the contents of which are fully incorporated herein by reference.

### BACKGROUND OF THE INVENTION

The present invention provides for a display for a medical device and for methods of displaying information relating to a monitored bodily parameter. In particular, the present invention provides for an easy-to-read display for displaying past and present information relating to a monitored bodily parameter and provides a means for displaying a projected future value for that parameter. Accordingly, various trends can be displayed using the present invention, including trends where a patient's bodily parameter is improving, remaining stable, or degenerating.

Medical monitors typically display discrete numeric information. For example, blood glucose monitors (“BGMs”) display a present blood glucose value. While some monitors might record and retain past historic values, these values are typically displayed in numeric form only and it is often not possible to display both past value and present value in the same viewing area. As medical monitoring devices become more compact, so do their viewing screens. Accordingly, it is desirable to display as much information as possible on a small screen. Perhaps even more importantly is a method for displaying past, present, and projected future data in a manner that is easy to read and easy to comprehend. The ability to display past, present, and future values for a monitored parameter becomes even more important as devices begin to continuously measure certain bodily parameters. For-example, as continuous BGMs (CBGMs) become available, it is desirable to display a large amount of past and present data in a simplified easy-to-understand manner.

Moreover, as medical devices become more sophisticated and more affordable, it is possible for patients to self-treat certain conditions. Diabetes for example, is a medical condition that often requires a patient to monitor her own blood glucose level and then make an adjustment to self-administered insulin doses. Likewise, hemophilia and other chronic long-term illness often are best managed when the patients monitors their condition and make adjustments to their treatment accordingly. While one-on-one care with a physician is often critical, the patient is often in the best position to make small and short term adjustments to their own treatment. Advances in computers and electronics have made it possible to monitor more and more medical conditions. Unfortunately, the people who tend to have the long-term illness that are best suited for self-treatment, tend to be older, have poorer eyesight, and less comfort with electronic devices. According, medical monitors for self-treatment need to provide accurate information in a simple and intuitive manner that is easy to understand and provides the patient viewing the information with sufficient data to adjust their treatment.

### SUMMARY OF THE INVENTION

The present invention may take many forms and be used with a plurality of diverse devices. In one embodiment, the present invention comprises a display screen on which a graphical display is projected. The graphical display may take many forms and may include display of numeric data along with a graphical representation of that data.

In one embodiment, the graphical display shows in a single viewing a past value for one monitored medical bodily parameter, a present value and a projected future value. The display may also show trend data such as whether the monitored parameter is moving toward an acceptable level or away from an acceptable level. The display may also show whether the present value is acceptable or whether the future value is predicted to be acceptable. One method of displaying whether the present (or future) value is acceptable, is to use one color for the graphical representation if the value is acceptable (or moving toward an acceptable value) and another color if the value is unacceptable (or moving toward an unacceptable value).

Another embodiment of the present invention may involve displaying the current time and displaying along with the time a graphical display showing the present level of a monitored parameter, trend information, and information about the monitoring device, such as battery capacity remaining, and need to calibrate the device. The device might also show graphically whether the monitored parameter is an acceptable level and the rate at which the level is changing. In some embodiments, all this information, and possibly more, will be visible in a single viewing.

### BRIEF DESCRIPTION OF THE DRAWINGS

The file of this patent contains at least one drawing executed in color. Copies of this patent with color drawing(s) will be provided by the Patent and Trademark Office upon request and payment of the necessary fee.

FIGS. 1a-1f illustrate one embodiment of the graphical display according to the present invention, wherein the display is circular.

FIGS. 2a-2f illustrate a second embodiment of the graphical display according to the present invention, wherein the display is square.

FIGS. 3a-3f illustrate a third embodiment of the graphical display according to the present invention.

### DETAILED DESCRIPTION OF THE INVENTION

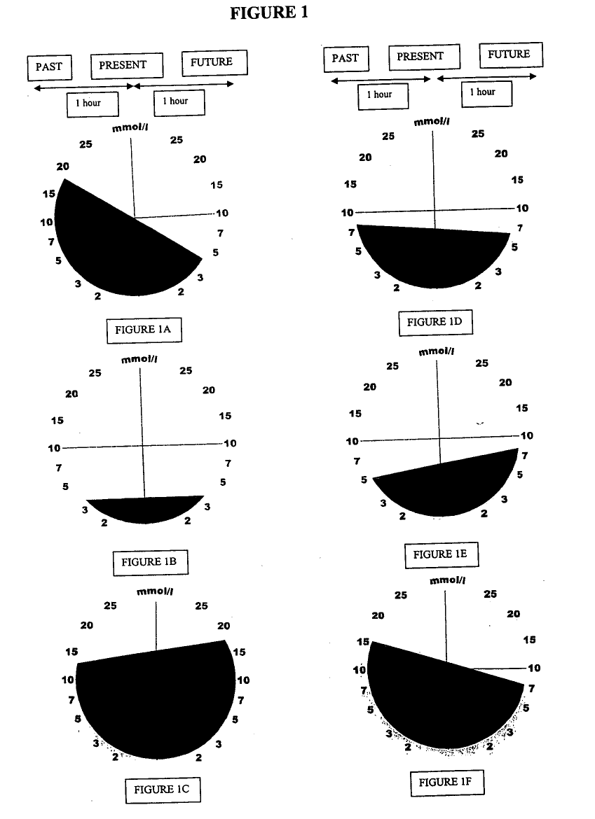

FIG. 1 illustrates six examples of the graphical display of the present invention. In these examples, the display is used with a blood glucose monitor. In FIG. 1a, the current patient blood glucose level is around 10 mmol/l, which could be an acceptable level. However one hour ago the level was close to 20 and with the current trend it is predicated that within the next hour the glucose concentration will decrease to a critical level. The color red indicates that the patient is “doing less good.”

FIG. 1b shows that the level has been at a stable, low level within the last hour. The concentration is below the critical level and the color is red.

FIG. 1c shows that the level has been relatively stable at a high level within the last hour. The concentration is increasing and above the critical level, so the color is red.

FIG. 1d shows that the concentration is at an acceptable level and only slightly decreasing. The color is green showing that the patient is “doing good.”

FIG. 1e shows the opposite situation depicted in FIG. 1d.

FIG. 1f shows that an hour ago the level was too high, but the level is decreasing and will reach an acceptable level within the next hour. The color is therefore green.

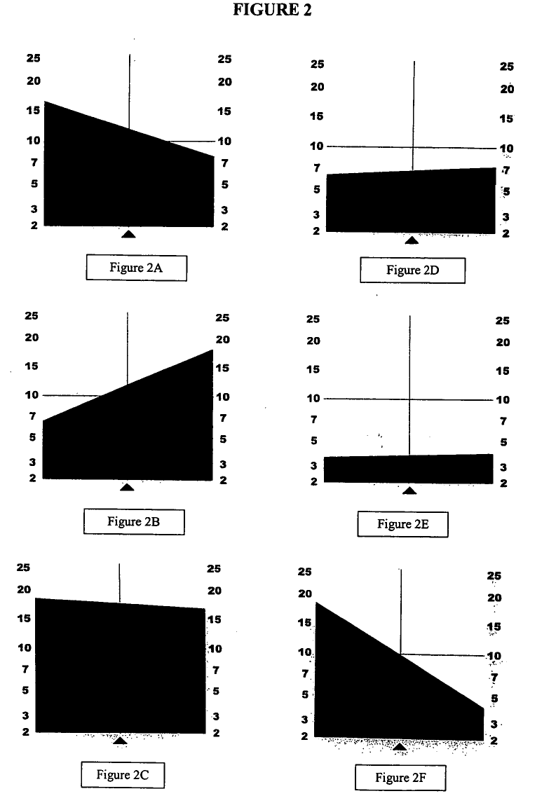

FIGS. 2a-2f illustrates that the display may be square. The display may, in fact, take virtually any shape.

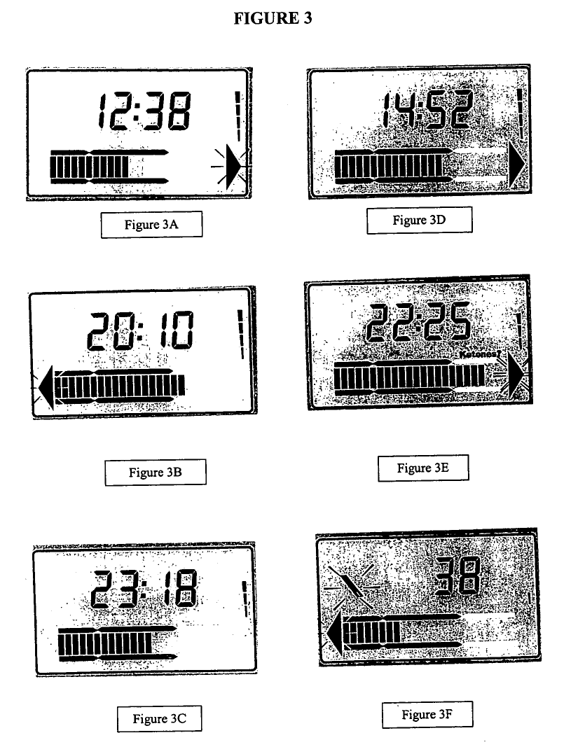

FIGS. 3a-3f illustrate a different embodiment, where the present time is displayed numerically and the blood glucose level, or other parameter of interest, is displayed graphically. This display also shows other information such as battery power, indicated on the right side of the display.

In FIG. 3a, the time is 12:38, the glucose level is within acceptable limits and increasing slowly. Slow flashing of the arrow on the right indicates the slow increasing nature of the glucose level. The vertical bars are within the green portion of the horizontal lines, which indicates an acceptable level. Battery life is at between 75 and 100%.

In FIG. 3b the time is 20:10 and glucose is within the higher region, and decreasing slowly. The arrow on the left indicates a decrease and its rate of flashing indicates whether the decrease is progressing slowly or quickly. The battery life is at between 75 and 100%.

FIG. 3c illustrates that the time is 23:18 and the blood glucose level has been constant (within a certain tolerance) for the last hour. No arrow is displayed. Battery life is between 50 and 75%.

FIG. 3d shows a time of 14:52 and glucose is within an acceptable range and is increasing fast. As a result, the arrow on the right flashes quickly. Battery life is between 75 and 100%.

In FIG. 3e, the time is 22:25 and glucose is within the higher region and fast increasing. Ketones might be a problem and should be checked. Battery capacity is between 50 and 75%.

FIG. 3f shows that the glucose level is within an acceptable range and slowly decreasing. A strip symbol is flashing showing that a calibration must take place. If the calibration does not occur within 38 minutes, the time on the display, the continuous blood glucose monitor tracker will be switched off. In some embodiments, the initial time for a calibration might be 60 minutes.

In some embodiments the display of the present invention may be incorporated into a medical monitoring device, such as the so-called watch-like CBGMs that are in the process of being developed. In other embodiments, the display portion of the medical monitoring device might be physically separate from the measuring portion of the device. For example, a CBGM might have one portion that comprises a penetrating component for penetrating the skin of a patient. Attached to the penetrating portion might be a measuring apparatus that comprises all components necessary to continuously monitor blood glucose levels. In some embodiments, the components connected to the skin penetrating device may be simplified and only contain components necessary to produce a signal. That signal could then be processed by a second device, which may contain a display having the unique features of the present invention. The second device may, in some embodiments merely take the signal from the first device and convert it into a value of the measured parameter. In other devices, it may do more sophisticated analysis and predict future values, exclude anomalies, suggest treatments, etc.

In some embodiments wherein the display is shown on a second unit of a bifurcated device, the second unit could be hard-wired to the display unit or it could be interfaced via wireless means, such as RF or infrared. The second device with the display means could also be a communication device for further transmitting information over the Internet or locally to a personal computer or similar device. In fact, the second device might be a PDA, cellphone, personal computer, or the like that is interfaced with the first unit. The interface may use a cable or wire or it might be a wireless interface. Regardless of how a monitoring device is physically configured, the present invention provides for embodiments where a display unit graphically shows data relating to the monitored parameter. Of course, the display unit may be part of a unit that contains a processor for processing data and for storing data. In some cases, the display unit and/or the monitoring sensor unit, might also incorporate, or at the very least, communicate with other devices for treating an illness.

While the present invention is well-suited for use with continuous blood glucose monitors, it can be used with other instruments as well.

We claim:

1. A continuous blood glucose monitor (“CBGM ”) comprising
a. a display for displaying graphics and characters;
b. a processor that is interfaced with a display; the processor being configured to display data on the display, the data being displayed in a graphical form showing, as a single image, past and present blood glucose values and trend data, the processor further being configured to calculate future blood glucose values and to display the future values simultaneously with the past and present data in the same image.

2. The CBGM of claim 1 wherein the processor is further configured to display a visual indication as to whether the blood glucose level is predicted to be an acceptable level at a predetermined time in the future, the indication comprising displaying the image in a first color for good and a second color for bad

3. A graphical display of a continuously monitored bodily parameter for displaying a single image comprised of a graphical representation of:
past monitored data, present data,
future data, and
trend data indicating whether a patient's condition is acceptable now and likely to be acceptable in the near future, or is unacceptable presently, but is likely to become acceptable within a discrete, preselected period of time.

4. A graphical display for a medical monitor for displaying information about a monitored bodily parameter, the display comprising:
a. a means for showing the present value of the parameter,
b. a means for showing information about the monitoring device,
c. a means for showing whether the monitored parameter has been relatively constant for a predetermined past period, whether the parameter value is increasing or decreasing, and the relative rate at which the parameter is changing, and
wherein the means a-c are displayed in a graphical form in a single viewing of the display.

5. A display for continuous blood glucose monitor, the display comprising:
a. a graphical representation of blood glucose data, the data comprising:
1. past blood glucose levels,
2. present blood glucose level,
3. future predicated blood glucose levels,
4. rate of change of blood glucose level,
b. a visual indicator that indicates whether:
1. the blood glucose level is at or approaching an acceptable level, or
2. a visually observable indicator that indicates whether the blood glucose level is unacceptable or approaching an unacceptable level.

6. The display of claim 5, wherein the visually observable indicator comprises one color for indicating an acceptable condition and another color for indicating an unacceptable condition.
